(19) United States
(12) Patent Application Publication
(10) Pub. No.: US 2021/0339121 A1
(43) Pub. Date: Nov. 4, 2021

(54) Simulouz

(71) Applicant: Terrelle Johnson, Palm Bay, FL (US)

(72) Inventor: Terrelle Johnson, Palm Bay, FL (US)

(21) Appl. No.: 16/865,383

(22) Filed: May 3, 2020

(51) Int. Cl. A63F 13/212; A63F 13/219; A63F 13/235; A63F 13/27; A63F 13/285

(52) U.S. Cl. CPC A63F 13/212; A63F 13/219; A63F 13/285; A63F 13/27; A63F 13/235

(57) ABSTRACT

The present invention discloses a virtual reality gaming system and its operations in detail. In some embodiments, the operations of the game include a creation of gaming zone in a dome shaped room where the ceiling and walls are covered with projector screen to create a live immersive scenery to play arcade style shooter video games. The gaming system includes a wireless game gun controller and a sleeveless wireless vest which are used in the game by player/s to play variety of arcade style shooting games.

### BACKGROUND

### Field of the Invention

This invention generally relates to virtual reality game systems which provide a three-dimensional (3D) immersive experience to game players, and more particularly, to methods for creating 3D vision displays in a doom shaped room and to make a live immersive scenery to play arcade style shooter video games and a mission control system where sleeveless wireless vest and wireless game gun controller will be used by the player/s.

### Description of the Related Art

With the development of society, people's living standards improve, people's cultural needs are also growing, and diverse cultural needs and promote the integration of digital technology, culture and entertainment, many modern science and technology and cultural products have emerged, especially in virtual reality application of technology more and more common. As Nintendo somatosensory game control device, Sony's head-mounted display, etc., as a game entertainment product developed. Especially in a shooting game, although some equipment so that users have been able to experience as immersive general visual impact, which greatly enhances the gaming initiative and realism. However, users play this shooting game, gaming devices can only give users a three-dimensional scene into the visual illusion, other users can only feel the lack of audio-visual, or reducing the user immersive feeling. There are multiple inventions that have been registered in prior art regarding use of virtual reality in playing Arcade games.

A U.S. Pat. No. 9,473,758B1 is a Methods and systems for game video recording and virtual reality replay is issued to Sliver VR Technologies, Inc. Methods and systems for processing computer game videos for virtual reality replay are disclosed. The method, when executed by a processor, comprises first receiving a video recorded using a virtual camera array during a game play of a source computer game. Next, upscaling the received video to a higher resolution, and interpolating neighboring video frames of the upscaled video for insertion into the upscaled video at a server. Finally, generating a spherical video from the interpolated video for replay in a virtual reality environment. The virtual camera array includes multiple virtual cameras each facing a different direction, and the video is recorded at a frame rate and a resolution lower than those of the source computer game. The spherical videos are provided on a video sharing platform. The present invention solves the chicken-and-egg problem of mass adoption of virtual reality technology by easily generating VR content from existing computer games.

A US patent 2,009,001,788,6A1 is a system and method for creating exalted video games and virtual realities wherein ideas have consequences is issued to Dr. Elliot McGucken. A video game method and system for creating games where ideas have consequences, incorporating branching paths that correspond to a player's choices, wherein paths correspond to decisions founded upon ideals, resulting in exalted games with deeper soul and story, enhanced characters and meanings, and exalted gameplay. The classical hero's journey may be rendered, as the journey hinges on choices pivoting on classical ideals. Ideas that are rendered in word and deed will have consequences in the game world. Historical events such as The American Revolution may be brought to life, as players listen to famous speeches and choose sides. As great works of literature and dramatic art center around characters rendering ideals real, both internally and externally, in word and deed, in love and war, the present invention will afford video games that exalt the classical soul, as well as the great books, classics, and epic films—past, present, and future.

A US2,012,014,2415A1 is a Video Show Combining Real Reality and Virtual Reality is issued to Lindsay L Jon. A video show is recorded in a tangible medium for distribution and presentation to an audience. The video show comprises video portions of a player based on a real person wearing a head mounted display through which the real person sees a virtual reality object with which the real person attempts to interact while moving within a real environment. The video show also comprises generated virtual video portions of the virtual reality object within a virtual reality environment and depicting any action of the virtual reality object in response to attempts by the real person to interact with the virtual reality object, at least a portion of the virtual reality environment corresponding to the real environment.

A Wearable virtual reality motion helmet and wearable virtual action game system bearing CN patent 1,048,577,04A is issued to Chinese inventor. The invention discloses a wearable virtual reality motion helmet and a wearable virtual action game system. The helmet comprises a three-dimensional image display screen, a sound player, a sensing unit, a vibration component, a process control unit running a three-dimensional virtual game, and a data transceiving unit. An enclosed virtual simulated visual and acoustic effect can be generated; and the viewing angle of the game scene can be changed by the turning and the direction change of the head. The helmet can be used in combination with auxiliary terminals such as a game gun, a gamepad, a sport jacket, game gloves, a treadmill and/or sport shoes, to make the human-machine interaction and the network competition of virtual games such as simulated gunnery, simulated driving, simulated outdoor live CS become easier; and real-time bidirectional information exchange can be achieved among the helmet, the auxiliary terminals and the network; the verisimilitude is enhanced by the vibration feedback, such as the vibration feeling like being really shot in shooting game competitions, thereby achieving the 5D interaction.

A Dynamic environment and location based augmented reality (ar) systems bearing US patent 2,014,028,780,6A1 is issued to SULON TECHNOLOGIES Inc. The invention discloses a multi dynamic environment and location based active augmented/mixed reality (AR) gaming system having means to utilize its surrounding environment and locations of other systems and devices in conjunction with computer based advanced calculation and graphics to dynamically change the gaming environment to any location and environment of a game play.

A US patent 2,002,015,421,4A1 is a virtual reality game system using pseudo 3D display driver is issued to Atlantis Cyberspace Inc. The patent discloses a virtual reality game system and method uses pseudo drivers to generate stereo vision outputs for a 3D stereoscopic display from game software normally intended for output to a 2D display of a conventional game console or PC. The Pseudo Drivers can convert the game data output of 3D video game software written in different application programming interface (API) formats commonly used for PC games to “stereo vision”, thereby allowing hundreds of existing 3D games to be played on a virtual reality game system. The intercepted 3D game data can be stored in a 3D data recorder for later play back. The 3D game data can also be transmitted or downloaded to a remote player through an online interface. The intercepted 3D game data can be combined with other 3D content through a mixer and dual rendering system, which facilitates control of the 3D display before, during, and after a game, and particularly when switching between different games. The Pseudo Driver for the 3D display can be operated in tandem with other pseudo drivers such as for stereo sound and\or directional force feedback.

A Virtual reality complete interactive system bearing US patent 2,004,025,968,8A1 is issued to Stabile Michael John. This invention is a device which allows for a full range of motions from a users upper and lower body for the purpose of enhancing a virtual simulation. The purpose of this device is to allow users to run both foreword, backwards, and side-to-side, and to allow the user to jump, crouch, prone, twist and turn while remaining centered over a control pad. The devices supports the user via the user's back allowing the user to perform any of the mentioned movements without having to hold onto any means of support with their hands. Any of the user's movements can be superimposed into a virtual scenario such as a video game, tactical simulator, physical fitness training software, etc. The invention includes a vest that attaches to the base on the user's back. This vest is highly adjustable allowing for a snug fit on the user for stability. The base itself consists of a floor piece that not only interprets the users footsteps but also can be manipulated by software to simulate a wide variety of terrains. The second part of the base is the swing arm that translates the user's orientation while keeping the user centered over the floor piece.

A Shooter Virtual reality vest bearing CN patent 2,074,779,52U is issued to a Chinese inventor. The present invention provides a virtual reality seed shooter vest, vest comprising a body and a control module disposed in the body on the vest, the signal input interface, and a plurality of independent vibration unit and the control signal input interface module and a vibration unit, respectively is connected with an external signal input interface connected to the game device in the control module to transmit the vibration information, the vibration control information processing module transmits a vibration signal to the vibrating unit. By providing a plurality of independent vibration means the vibration feedback information, the user during use, can be independent of the vibration means by its own vibration and improve realism when users.

It has to be noted that the current invention proposes an advancement in providing an assembly which is fully interactive and provide a life sized virtual reality experience. The players play the video game in a dome room which is a life-sized game room that creates an immersive environment allowing players to play an arcade style shooter. The wireless game gun controller and wireless sleeveless vest allow motion sensors to identify enemy attacks, response and other movements, thus in turn making a real life experience within the personal space facility.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of virtual reality arcade gaming system.

It is another objective of the invention to provide an immersive game room that let players play arcade style shooting video games.

It is further the objective of the invention to provide a gaming system which allow single or multiple players to play simultaneously.

It is also the objective of the invention to provide a realistic wireless game controller shaped in a form of shooting gun.

It is another objective of the invention to provide a motion sensor vest that trigger real life enemy attacks.

A further object is to provide an assembly that is simple and easy to use and support multiple types of shooting games

A still further object is to provide an assembly that is economical in cost to manufacture and easy to install as well.

It is a further object of the present invention to provide a improved gaming assembly which is of a durable and reliable construction.

Still yet another object of the present invention is to provide a new and improved virtual reality arcade gaming assembly which provides in the apparatuses and methods of the prior art some of the advantages thereof, while simultaneously overcoming some of the disadvantages normally associated therewith.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

One aspect of the present application is directed to provide a live immersive arcade style gaming experience using the wireless sensors equipped vest and wireless game controller.

As per preferred embodiment of the invention the current invention discloses an assembly where an immersive scenery to play arcade style shooter video games for multiple players is proposed. The invention discloses a gaming setup which is ideally set up in a dome shaped building with a proposed dimension of 15 ft in height and 15 ft across in diameter. The players are equipped with a wireless game gun controller that will interact with on the screen activities. A sleeveless wireless vest will also be worn across player torso. The vest functions will have motion sensors that identify player movement and coordinated enemy attacks from the video screen wherever in the room.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 shows the front view of the motion sensor vest;

FIG. 2 shows the perspective view of the game controller;

FIG. 3 shows how our Invention works.

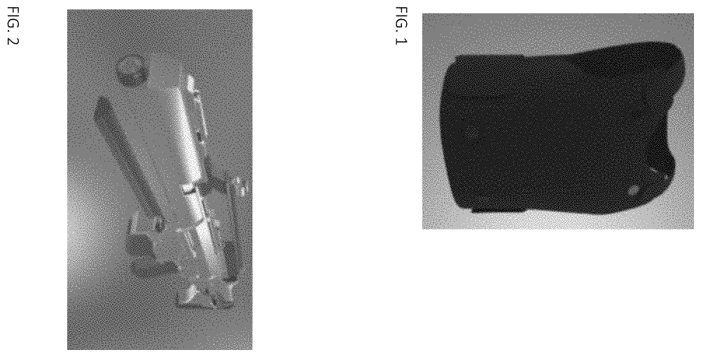

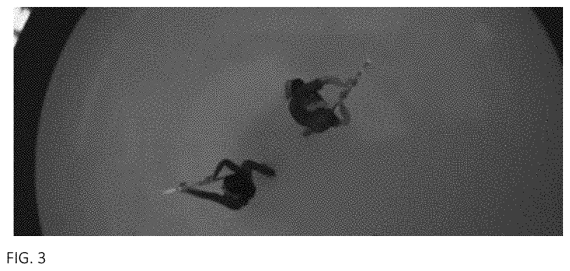

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

1: A doom shaped shooting game virtual reality setup including wireless gun shaped controller and sensor embedded vest, characterized in the gaming assembly.
A wireless game controller shaped in a form of gun which user uses to play arcade style shooting games.

2: A vest provided in the body and in the control module on the body of the vest, a plurality of separate signal input interface, and a vibration unit; with sensors allowing to identify player movement and respond to enemy attacks from the video screen.
A said body comprises a body vest front portion and a back portion, the front body portion and the back portion around to form a cavity, the left and right sides of the front body portion are arranged the inbuilt sensors.
a wireless sleeveless vest where wherein: the fastener is a Velcro, snaps or buckles three guards.
A virtual reality vest, characterized in that: said vibration means comprises electromagnetic waves activated by inbuilt sensors. Moreover, it is a motion sensor vest which triggers real life enemy attacks.
